(19) United States
(12) Patent Application Publication
(10) Pub. No.: US 2025/0147710 A1
(43) Pub. Date: May 8, 2025

(54) DATA MIRRORING FOR A VIRTUAL ENVIRONMENT

(71) Applicant: Micron Technology, Inc., Boise, ID (US)

(72) Inventors: John D. Hopkins, Milpitas, CA (US); Mohad Baboli, Boise, ID (US)

(21) Appl. No.: 18/500,572

(22) Filed: Nov. 2, 2023

Related U.S. Application Data
(60) Provisional application No. 63/425,615, filed on Nov. 15, 2022.

(51) Int. Cl. G06F 3/14; G06T 3/40; G06T 11/60

(52) U.S. Cl. CPC G06F 3/1454; G06T 3/40; G06T 11/60

(57) ABSTRACT

Methods, apparatus, and non-transitory machine-readable media associated with mirroring data for a virtual environment. An apparatus can include a memory device and a processor communicatively coupled to the memory device. The processor can receive data for display from a different apparatus that is coupled to the apparatus, wherein the different apparatus is a physical apparatus. The processor can modify image data for a virtual environment using the data. A display system coupled to the processor can display the modified image data of the virtual environment to mirror the data from the different apparatus to the virtual environment.

### PRIORITY INFORMATION

This application claims the benefit of U.S. Provisional Application No. 63/425,615, filed on Nov. 15, 2022, the contents of which are incorporated herein by reference.

### TECHNICAL FIELD

The present disclosure relates generally to apparatuses, non-transitory machine-readable media, and methods associated with mirroring data for a virtual environment.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Virtual reality (VR) is a simulated experience that can be similar to or completely different from the real world. VR can be utilized for entertainment, education, and business, among other applications.

### BRIEF DESCRIPTION OF THE DRAWINGS

FIG. 1 illustrates example computing systems for mirroring data in accordance with some embodiments of the present disclosure.

FIG. 2 illustrates a diagram of a virtual environment in accordance with some embodiments of the present disclosure.

FIG. 3 illustrates a diagram of a virtual environment in accordance with some embodiments of the present disclosure.

FIG. 4 illustrates a block diagram of an interface for mirroring data in accordance with some embodiments of the present disclosure.

FIG. 5 is a flow diagram corresponding to a method for mirroring data to a virtual environment in accordance with some embodiments of the present disclosure.

FIG. 6 is a block diagram of an example computer system in which embodiments of the present disclosure may operate.

### DETAILED DESCRIPTION

Apparatuses, machine-readable media, and methods related to mirroring data for a virtual environment are described. In various instances, a first computing system can mirror data to a second computing system. The second computing system can modify image data for a virtual environment using the data provided by the first computing system for mirroring. The second computing system can display the modified image data in the virtual environment to mirror the data from the first computing system to the virtual environment.

A virtual environment can include VR and/or augmented reality, for example. The virtual environment can be an augmented reality environment and/or a metaverse. The metaverse can be implemented using VR and/or augmented reality. The metaverse is a virtual environment in which users can interact with a computer-generated environment and/or other users. Users in the metaverse can utilize an avatar to interact with avatars of other users and/or the virtual environment. The avatar can have a graphical representation which can interact with the computer-generated environment of the virtual environment.

In previous approaches, a user participating in a virtual environment using a first computing system may have to exit the virtual environment prior to interacting with a second computing system. For example, the second computing system can comprise a phone. The phone can receive a message. The user may not be able to read the message from the phone given that the first computing system may impair the user's ability to interact with the phone.

Aspects of the present disclosure address the above and other deficiencies by mirroring data from the second computing device to the first computing device. Mirroring data from the second computing device to the first computing device can allow a user to interact with the second computing device without having to leave a virtual environment by disconnecting from the first computing system.

As used herein, a user can disconnect from the first computing system by physically creating distance from the first computing system. The first computing system can be a headset (e.g., a VR headset) that can be used to participate in the virtual environment. The user can disconnect from the headset by removing the headset such that the user can no longer interact with the virtual environment. As used herein, a headset can include a head-mounted computing system that allows a user to interact with a virtual environment. The user can remove the headset by taking the headset off.

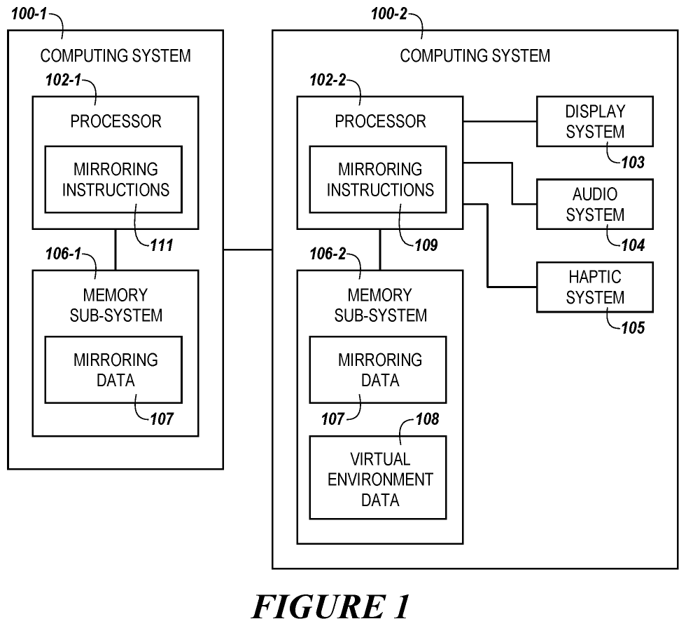

FIG. 1 illustrates example computing systems 100-1, 100-2 for mirroring data in accordance with some embodiments of the present disclosure. The computing systems 100-1, 100-2 can be referred to as computing systems 100. The computing systems may also be referred to as computer systems. The computing systems 100-1, 100-2 illustrated in FIG. 1 can be a server, a computing device, a VR headset, a phone (e.g., a cellular device), a tablet, and/or an internet of things (IOT) device, and can include the processing devices 102-1, 102-2 (e.g., processing resources, processors). The computing systems 100 can further include the memory sub-systems 106-1, 106-2 (e.g., a non-transitory MRM), on which may be stored instructions (e.g., mirroring instructions 109, 111) and/or data (e.g., mirroring data 107). Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory sub-systems 106-1, 106-2, referred to as memory sub-systems 106, may comprise memory devices. The memory devices may be electronic, magnetic, optical, or other physical storage device that stores executable instructions. One or both of the memory devices may be, for example, non-volatile or volatile memory. In some examples, one or both of the memory device is a non-transitory MRM comprising RAM, an Electrically-Erasable Programmable ROM (EEPROM), a storage drive, an optical disc, and the like. The memory sub-systems 106 may be disposed within a controller and/or the computing systems 100. In this example, the executable instructions 109, 111 can be “installed” on the computing systems 100. Additionally, and/or alternatively, the memory sub-systems 106 can be portable, external or remote storage mediums, for example, that allows the computing systems 100 to download the instructions 109, 111 from the portable/external/remote storage mediums. In this situation, the executable instructions may be part of an “installation package”. As described herein, the memory sub-systems 106 can be encoded with executable instructions for mirroring data.

The computing system 100-1 can execute the mirroring instructions 111 using the processing device 102-1. The mirroring instructions 111 can be stored in the memory sub-system 106-1 prior to being executed by the processing device 102-1. The execution of the mirroring instructions 111 can cause the mirroring data 107 to be provided to the computing system 100-2. The mirroring data 107 can comprise any data generated by the computing system 100-1 and/or any data accessed by the computing system 100-1.

For example, the computing system 100-1 can be a cellular device (e.g., cellular phone). The computing system 100-1 can receive data as part of a cellular connection, for instance. The computing system 100-1 can receive the data (e.g., access the data) which can comprise audio data and/or image data. The computing system 100-1 can store the data and/or can provide the data to the computing system 100-2. The data provided to the computing system 100-2 can be referred to as mirroring data 107. As previously stated, the mirroring data 107 can be audio data and/or image data. The computing system 100-1 can provide the mirroring data 107 by executing the mirroring instructions 111. In various instances, the execution of the mirroring instructions 111 can cause the mirroring data 107 to be streamed to the computing system 100-2 or provided to the computing system 100-2 for download. Streaming can describe the providing of the data in real-time as the data is being received while downloading can describe the providing the data at a different time than the data is received.

The computing system 100-2 can receive the mirroring data 107 and can store the mirroring data 107 in the memory sub-system 106-2. The computing system 100-2 can cause the mirroring instructions 109 to access the mirroring data 107 by retrieving the mirroring data 107 from the memory sub-system 106-2, for example. The mirroring instructions 109 and the mirroring instructions 111 utilize different reference numbers (e.g., 109, 111) even though they have a same label (e.g., mirroring instructions) because they perform different functions. For example, the mirroring instructions 111 can be utilized to provide data to the computing system 100-2 while the mirroring instructions 109 can be utilized to provide the data to a user.

The processing device 102-2 that is coupled to the memory sub-system 106-2 can access the mirroring instructions 109 and the virtual environment data 108 from the memory sub-system 106-2. The virtual environment data 108 can represent data that can be utilized to create a virtual environment. The user can interact with the virtual environment utilizing a display system 103, an audio system 104, and/or a haptic system 105, among other systems that can be utilized to allow a user to interact with the virtual environment.

As used herein, the display system 103, the audio system 104, and/or the haptic system 105 comprises hardware, firmware, and/or software that is utilized to allow a user to interact with a virtual environment represented by the virtual environment data. The display system 103 can include a display that can be utilized to provide images to a user. The images can include 2-dimensional (2D) images and/or 3-dimensional (3D) images, among other types of images that can be provided to a user. The images can correspond to images of the virtual environment. The audio system 104 can be utilized to provide sounds to the user. The sounds can correspond to sounds of the virtual environment. The audio system 104 can include, for example, speakers and/or microphones. The microphones can be used to capture and/or generated audio data from sounds generated by a user. The audio data generated by the user can be used to interact with the virtual environment and/or with the computing system 100-1.

The haptic system 105 can be utilized to provide an experience of touch to a user by applying forces, vibrations, and/or motion. The haptic system 105 can be utilized to allow a user to interact with the virtual environment and/or the computing system 100-1. For example, the haptic system 105 can allow a user to “touch” virtual objects of the virtual environment or to give commands to the virtual environment.

In various instances, the computing system 100-2 can comprise other system that can be used to interact with a virtual environment. The computing system 100-2 can include cameras that can be utilized to capture facial expressions, hand gestures, and/or body movements of a user which can be utilized to interact with the virtual environment. The computing system 100-2 can also comprise joysticks which can be used to provide selections from the user to the virtual environment.

The mirroring instructions 109 can be executed to integrate the mirroring data 107 into the virtual environment data 108. The mirroring data 107 can be integrated into the virtual environment data 108 by merging the mirroring data 107 with the virtual environment data 108.

Integrating the mirroring data 107 into the virtual environment data 108 allows the user to access the mirroring data 107 while remaining engaged with the virtual environment. Allowing a user to access the mirroring data 107 can include allowing a user to interact with the computing system 100-1 while remaining engaged with the virtual environment.

In various instances, the execution of the mirroring instructions 109 can cause commands from a user to be received and/or actions of the user to be interpreted as command which can be utilized to provide response data to the computing system 100-1. The response data can be provided by the user responsive to the user interacting with the mirroring data 107. As used herein, the data that the user interacts with in the virtual environment and which corresponds to the mirroring data 107 can be referred to a mirroring data 107 or data generally.

The computing system 100-1 can utilize the response data to perform further operations. For example, if the mirroring data 107 comprises audio data from a phone call, then the response data can comprise audio data providing an audio response to the mirroring data 107. If the mirroring data 107 is text data from a text message received by the computing system 100-1, then the response data can comprise a response text which the computing system 100-1 can utilize to respond to the text message. If the mirroring data 107 is data generated by an application executed by the processing resource 102-1, then the response data can include data which can be utilized to further interact with the application.

The mirroring data 107 can be utilized to modify the virtual environment data 108 in such a way that the user has access to the mirroring data 107. For instance, if the mirroring data 107 comprises text data (e.g., text), then the mirroring instructions 109 can be executed to modify the virtual environment data 108 to include the text data.

In various instances, the mirroring data 107 can be provided to the user in a format that is different from the format of the mirroring data 107. The format of the data can include a type of the data. For example, if the mirroring data 107 is provided in a text format, then the mirroring instructions 109 can be executed to change a type of the mirroring data 107 from text data to audio data and/or haptic data. The virtual environment data 108 can be modified such that the audio system 104 is utilized to provide the text data in an audio format to the use. Providing the text data to the user in an audio format can include mirroring the data to the user in an audio format. For example, the characteristics of the mirroring data 107 can be translated to sounds (e.g., words) which the user can hear where the characteristics of the mirroring data 107 and the words (e.g., audio) have the same meaning. Likewise, audio data can be translated to characters (e.g., text data) which the user can read, and which comprise the same meaning.

The mirroring data 107 and/or the translated data can be used to modify the virtual environment data 108. For example, the virtual environment data 108 can include the mirroring data 107 such that the user can access the mirroring data. For example, the user can read the mirroring data 107 in the virtual environment utilizing the display system 103, the user can hear the mirroring data 107 in the virtual environment utilizing the audio system 104, and/or the user can feel the mirroring data 107 in the virtual environment utilizing the haptic system 105. The virtual environment data 108 can comprise display data, audio data, and/or haptic data, among other types of data that can be used to represent the virtual environment.

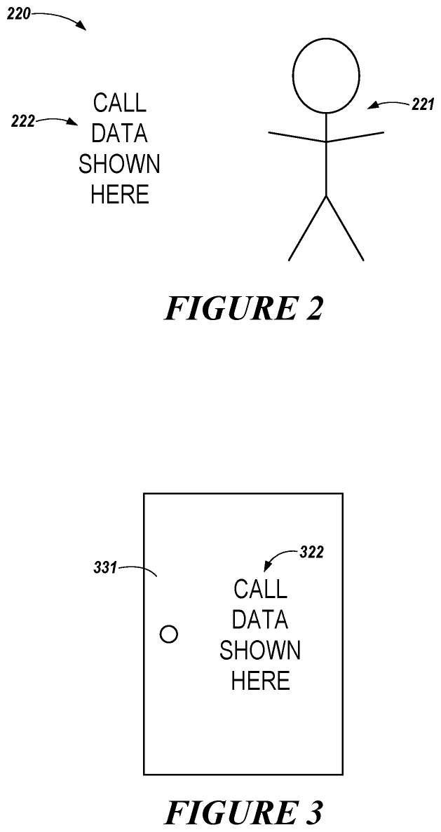

FIG. 2 illustrates a diagram of a virtual environment 220 in accordance with some embodiments of the present disclosure. The virtual environment 220 can be generated or at least a portion of the virtual environment 220 can be generated using the virtual environment data. The virtual environment data can be used to provide the virtual environment 220 to the user via a visual system, audio system, and/or haptic system, among other systems that can be used to provide the virtual environment 220.

The virtual environment 220 can comprise computer-generated objects. For example, the virtual environment 220 can include an avatar 221, among other possible objects that can be included in the virtual environment 220. The virtual environment 220 can also include structural objects such as buildings and/or cars, among other types of structures objects. The virtual environment 220 can further include landscape objects such as mountains, rivers, streams, clouds, rain, and/or valleys, among other landscape objects.

The data 222 corresponding to the mirroring data 107 of FIG. 1 can be shown in the virtual environment 220. In various instances, the data 222 can be the mirroring data 107. The data 222 can also be generated from the mirroring data 107. For example, the mirroring data 107 can include audio data from a call. The mirroring instructions of the computing system implementing the virtual environment 220 can be executed to translate the mirroring data to the data 222 which can be text data comprising characters that form words. The data 222 is shown at comprising the characters “Call Data Shown Here” to indicate a location in which the data 222 is shown to the user.

In various instances, the data 222 can be displayed to a user in a periphery of a visual space. For example, the avatar 221 can be displayed in the center of the visual space while the data 222 is shown in the periphery of the visual space.

Metadata corresponding to the mirroring data 107 of FIG. 1 can be received along with receipt of the mirroring data 107. The metadata can describe characteristics of the mirroring data. For example, if the mirroring data comprises text, then the metadata can describe a font type of the metadata and/or a font size of the metadata.

The data 222 can be displayed in the virtual environment 220 utilizing the metadata of the mirroring data. For example, the font and/or font size of the metadata of the mirroring data can be utilized to display the data 222 in the virtual environment 220. In various instances, the data 222 can be displayed in the virtual environment 220 without the utilization of the metadata of the mirroring data. For instance, the font and/or font size of the metadata of the mirroring data can be different from the font and/or font size utilized to display the data 222 in the virtual environment.

The characteristics of the data 222 can be selected based on a theme utilized in the virtual environment 220. For example, the font and/or font size, among other characteristics of the data 222 can be selected based a menu theme of the virtual environment 220 and/or based on a theme of an object of the virtual environment 220. For instance, if a room of the virtual environment 220 has a horror theme, then the font size and/or font of the data 222 can be selected such that the data 222 blends into the horror theme.

In various instances, the mirroring instructions can be executed to select effects used to display the data 222. As used herein, an effect of the data 222 can describe a characteristic of the data that changes over time. For example, a movement of the data 222 can be an effect that is selected for displaying the data 222. The position of the data 22 can change over time. The effects can be a 3D effect and/or a 2D effect.

In various instances, the data 222 can be displayed as an object in the virtual environment 220. For example, an object can be created, and the object can be modified to take the form of the data 222 such that the user can read the object taking the form of the data 222 in instances where the data reflects text or has been translated from the mirroring data to reflect text. The user may be able to interact with the objects taking the form of the data 222. For example, the user may “feel,” through the haptic system, the data 222 and may not be able to walk through the data 222 (e.g., objects taking the form of the data 222). The user may move the objects taking the form of the data 222, for example.

As previously described, the data 222 may be translated from the mirroring data such that the type of the data 222 is not the same as the type of the mirroring data. In various instances, the avatar 221 can be modified to convey the data 222 rather than having the data 222 displayed in the virtual environment 220. For example, the avatar 221 can deliver the data in an auditory manner. The avatar 221 can “speak” the data. The avatar 221 can be configured to move such that the data 222 is spoken, sung, screamed, or any other means of conveying the data 222 such as through signs language. In various instances, the facial features or gestures of the avatar 221 can be modified to convey the data 222 or a mood of the data. For example, if the data 222 conveys joy, then the avatar 221 can be modified to have “happy” facial expressions using a smile. In various instances, the avatar 221 can be clothes in such a manner as to enrich the message of the data 222. For example, the avatar can be clothed in a swimwear if the data 222 is an invitation to go swimming.

The metadata corresponding to the mirroring data can comprise a phone number from which a phone call was received. The phone number can be utilized to identify an account in the virtual environment 220. The avatar 221 corresponding to the identified account can be utilized to deliver the data 222. The avatar 221 can be summoned upon receipt of the data 222.

FIG. 3 illustrates a diagram of a virtual environment 320 in accordance with some embodiments of the present disclosure. The virtual environment 320 can include a door 331. The door 331 can be a 3D object having the shape of a door and functioning as a door in the virtual environment 320.

The mirroring instructions can be utilized to modify objects of the virtual environment 320 to display the data 322. For instance, the door 331 can be modified to display the data 322. A texture of the object can be modified to show the data 322. A grain of the door 331 can be modified to display the data 322, a color of the object can be modified to show the data 322, and/or a material of the object can be modified to display the data 322 among other characteristics of the object that can be modified to display the data 322.

Objects separate from the door 331 (e.g., door object) can be generated and affixed to the door 331. For instance, a sign object can be generated and configured to display the data 322. The sign object can be hung on the door 331 (e.g., door object).

The objects modified to display the data 322 are not limited to a door but can include any object in the virtual environment 320. For instance, a wall can be modified to display the data 322. A road can be modified to display the data 322. Mountains and/or clouds of the virtual environment 320 can be modified to display the data 322.

An object can be modified to display the data in a braille format which can be different than the format in which the mirroring data was received. For example, the mirroring data can comprise text (e.g., characters) and the text can be translated to a brail. The object (e.g., the door 331) can be modified to display the data 322 in braille. Modifying the object to display the data 322 in braille can allow an individual to utilize the virtual environment 320 using the haptic system to interact with a computing system that generated the mirroring data. For example, a user can receive a message on a phone. The user can utilize the virtual environment 320 to read the message using the surface of the door 331 that has been modified to include the data 322 in braille.

Similarly, users can utilize the virtual environment 320 to translate a message from a first language to a second language. For example, the mirroring data can be in a first language. The mirroring instructions can translate the mirroring data in a first language to the data 322 in a second language. An object of the virtual environment 320 can be modified to display the data 322 in the second language which can make the data 322 accessible to a user who speaks the second language but not the first language.

Regardless of how the data 322 is delivered to the user, the user can respond to the data 322. The response can be provided to a computing system that generated or provided the mirroring data. The computing system can perform actions responsive to receipt of the response. For example, the data 322 can be a text message. The user can respond to the data 322 by speaking a response. A microphone of the computing system used to provide the virtual environment 320 can be utilized to capture the response. The mirroring instructions can convert the audio response to a text response. The computing system used to display the virtual environment 320 can provide the text response to the computing system that provided the mirroring data. The computing system that provided the mirroring data can respond to the text message with the text response.

In various examples, the response can be data that can be used as an input to an application. For example, the response can comprise instructions to a gaming application executed on a phone. The response can be provided to the phone such that the application generates mirroring data, a next sequence in a game, which can be provided to the user via the virtual environment 320.

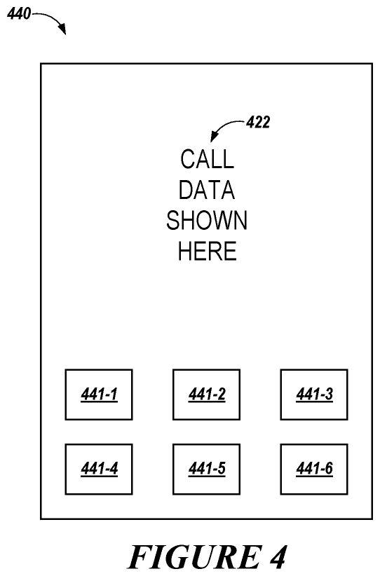

FIG. 4 illustrates a block diagram of an interface 440 for mirroring data in accordance with some embodiments of the present disclosure. The interface 440 can include the data 422 and the buttons 441-1, 441-2, 441-3, 441-4, 441-5, 441-6, referred to generally as buttons 441. The buttons 441 can include a prompt that can be used to convey and/or select a function.

In various instances, the interface 440 can be generated and the data 422 can be displayed in the interface 440. The interface 440 can be an object in the virtual environment. The interface 440 can be displayed to the user in the virtual environment without creating an object to display or convey the data 422.

In various instances, the mirroring data may not be associated with an interface 440. The interface 440 can be generated by the mirroring instructions to convey the data 422 to the user. The interface 440 can be different from an interface used to display the mirroring data to a user of a phone which provided the mirroring data. For example, the interface 440 can comprise functionalities which are different from the functionalities of the interface of the phone. The functionalities of the interface 440 can be selected using the buttons 441.

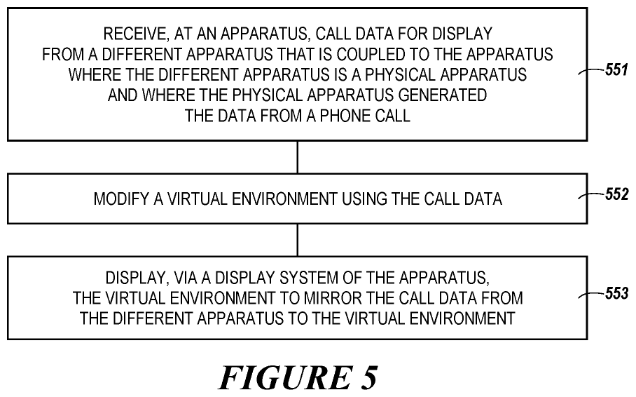

FIG. 5 is a flow diagram corresponding to a method 550 for mirroring data to a virtual environment in accordance with some embodiments of the present disclosure. The method 550 may be performed, in some examples, using a computing system such as those described with respect to FIG. 1. The method 550 can include the mirroring of data from one computing system to another computing system.

At 551, call data can be received at an apparatus for display from a different apparatus that is coupled to the apparatus. The different apparatus is a physical apparatus. The physical apparatus can generate the data from a phone call.

At 552, a virtual environment can be modified using the call data. For example, the virtual environment can be modified to display the call data, convey the call data using an audio system, and/or convey the call data using a haptic system. At 553, the virtual environment can be displayed, via a display system of the apparatus, to mirror the call data from the different apparatus to the virtual environment.

The call data can be processed to generate processed data. For example, the data can be processed to translate the data from a first language to a second language. The virtual environment can be modified using the processed data. For example, audio data of the virtual environment can be modified to include the processed data. Audio data can include spoken words and/or noises for example. Image data of the virtual environment can be modified to include the processed data. The image data can include 2D or 3D images. Image data can include images of text (e.g., characters) or pictures/illustrations. Haptic data of the virtual environment can be modified to include the processed data. The virtual environment can be comprised of image data, audio data, and/or haptic data, among other types of data that can comprise the virtual environment. The image data, the audio data, and/or the haptic data, when combined, can comprise the virtual environment data which can be used to create the virtual environment.

In various examples, a processor of a computing system can receive data for display from a different apparatus that is coupled to the computing system. The different apparatus (e.g., computing system) can be a physical apparatus as oppose to a virtual apparatus. The physical apparatus can be a physical phone. The computing system and the different apparatus can be coupled via a Bluetooth connection, a cellular connection, and/or a physical connection, for example. The processor can modify image data for a virtual environment using the data. Modifying the image data can include modifying the virtual environment to convey the data to the user.

The processor can be coupled to a display system of the computing system. The display system can display image data of the virtual environment. For example, the display system can display the modified image data of the virtual environment to mirror the data from the different apparatus to the virtual environment.

In various instances, the data can be data generated from a phone call received by the physical phone. For example, the data can be audio data generated during a phone call. The data can also correspond to data generated by an application executed on the different apparatus.

The user can interact with the data in the virtual environment. For example, the user can verbally respond to text data. A microphone can capture the verbal response and generate audio data. The processor can identify the audio data as a user interaction with the data. The processor can provide signals to the different device. The signals can comprise the user interaction with the data. The different device can take an action responsive to receipt of the signals.

In various examples, the processor can add a user interface to the data prior to modifying the image data. The user interface can be different than an interface utilized by the different device to display the data. The user interface can have different functionalities than the functionalities of the interface of the different device. The user interface can comprise one or more of an audio interface, a visual interface, and/or a haptic interface. For example, the user interface can comprise a visual interface and an audio interface provided via the virtual environment.

The processor can be used to include the data in the virtual environment. The processor can add the data to the image data in a peripheral field of view. The processor can also add the data to the image data in a central field of view. The processor can set a size of a display of the data in the virtual environment without reference to a size of a display of the data in the different device. The processor can modify a computer-generated environment of the virtual environment to incorporate the data with the computer-generated environment. For example, the computer-generated environment can comprise objects that represent different portions of the virtual environment. The computer-generated environment can comprise a mountain or a river, for example.

In various examples, call data can be received at a processor of an apparatus for display. The call data can be received from a physical phone that is coupled to the physical apparatus. The image data for a virtual environment can be modified using the call data. The image data can also be modified to include a prompt for functions to be performed utilizing the call data. The prompt can be included in an interface that is generated to make the call data accessible in the virtual environment. The modified image data can be displayed, via a display system of the apparatus, in the virtual environment to mirror the call data from the different apparatus to the virtual environment. A function can be performed based on a user interaction with the prompt.

The function can be a function not provided by the physical phone. The function can filter the call data. For example, the function can lower a tone of the call data or raise the tone of the call data. The function can remove background noise from the call data. The function can modify an avatar of the virtual environment to recite the call data. The function(s) can be utilized to allow a user to indicate how the user wants to interact with the call data. The avatar can be generated without being associated with a user account of the virtual environment. The avatar can correspond to a profile (e.g., user profile) of a participant of a phone call implemented using the physical phone. The profile can be a user profile of the virtual environment. The user profile and the participant of the phone call can be associated using a phone number of the participant of the phone call. For instance, the user profile can be associate with the phone number such that the processor can determine that the avatar corresponds to the participant.

In various instances, the call data can be provided to the computing system using a stream of data. The stream can provide real-time data to the computing system for display in the virtual environment.

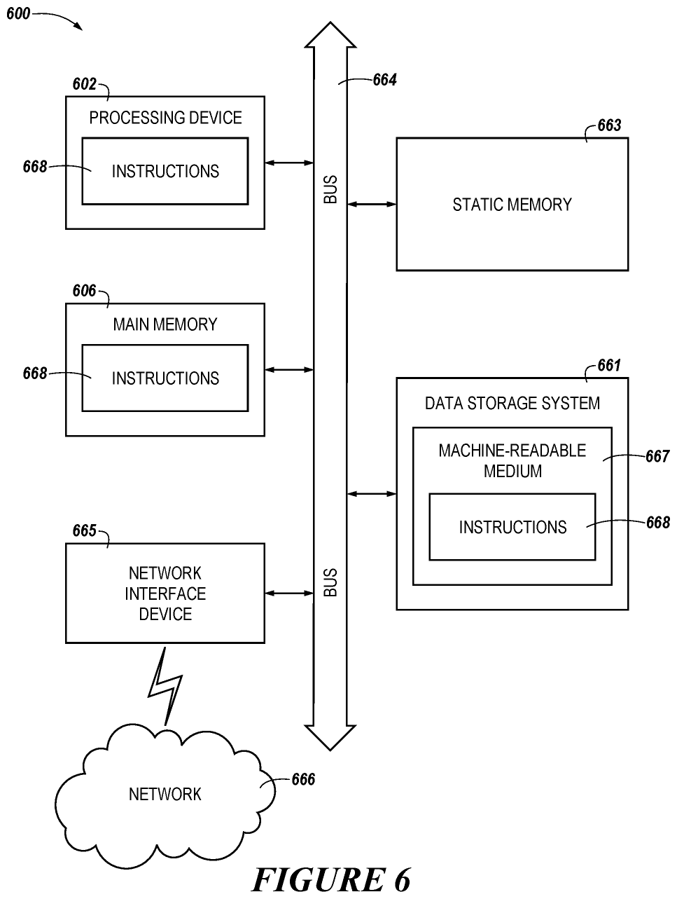

FIG. 6 is a block diagram of an example computer system 600 in which embodiments of the present disclosure may operate. For example, FIG. 6 illustrates an example machine of a computer system 600 within which a set of instructions, for causing the machine to perform any one or more of the methodologies discussed herein, can be executed. In some embodiments, the computer system 600 can correspond to a host system that includes, is coupled to, or utilizes a memory sub-system (e.g., the memory sub-system 106-2 of FIG. 1). The computer system 600 can be used to perform the operations described herein (e.g., to perform operations corresponding to the processor 109 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device (e.g., processor) 602, a main memory 606 (e.g., read-only memory (ROM), flash memory, dynamic random access memory (DRAM) such as synchronous DRAM (SDRAM) or Rambus DRAM (RDRAM), etc.), a static memory 663 (e.g., flash memory, static random access memory (SRAM), etc.), and a data storage system 661, which communicate with each other via a bus 664.

The processing device 602 represents one or more general-purpose processing devices such as a microprocessor, a central processing unit, or the like. More particularly, the processing device 602 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 668 for performing the operations and steps discussed herein. The computer system 600 can further include a network interface device 665 to communicate over the network 666.

The data storage system 661 can include a machine-readable storage medium 667 (also known as a computer-readable medium) on which is stored one or more sets of instructions 668 or software embodying any one or more of the methodologies or functions described herein. The instructions 668 can also reside, completely or at least partially, within the main memory 606 and/or within the processing device 602 during execution thereof by the computer system 600, the main memory 606 and the processing device 602 also constituting machine-readable storage media. The machine-readable storage medium 667, data storage system 661, and/or main memory 606 can correspond to the memory sub-system 106-2 of FIG. 1.

In one embodiment, the instructions 668 include instructions to implement functionality corresponding to mirroring data to a virtual environment (e.g., using processor 102 of FIG. 1). While the machine-readable storage medium 667 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a processor configured to:
receive data for display from a different apparatus that is coupled to the apparatus, wherein the different apparatus is a physical apparatus; and
modify image data for a virtual environment using the data; and
a display system coupled to the processor and configured to:
display the modified image data of the virtual environment to mirror the data from the different apparatus to the virtual environment.

2. The apparatus of claim 1, wherein the different apparatus is a physical phone.

3. The apparatus of claim 2, wherein the data corresponds to a phone call using the physical phone.

4. The apparatus of claim 1, wherein the data corresponds to an application executed on the different apparatus and wherein the processor is further configured to:
identify a user interaction with the data in the virtual environment; and
provide signals to the different device comprising the user interaction with the data.

5. The apparatus of claim 1, wherein the processor configured to:
modify the image data for the virtual environment using the data is further configured to add a user interface to the data prior to modifying the image data,
wherein the user interface is different than an interface utilized by the different device to display the data, and
wherein the user interface comprises one or more of an audio interface, a visual interface, and a haptic interface.

6. The apparatus of claim 1, wherein the processor configured to modify the image data for the virtual environment using the data is further configured to add the data to the image data in a peripheral field of view.

7. The apparatus of claim 1, wherein the processor configured to modify the image data for the virtual environment using the data is further configured to set a size of a display of the data in the virtual environment without reference to a size of a display of the data in the different device.

8. The apparatus of claim 1, wherein the processor configured to modify the image data for the virtual environment using the data is further configured to modify a computer-generated environment of the virtual environment to incorporate the data with the computer-generated environment.

9. A method comprising:
receiving, at an apparatus, call data for display from a different apparatus that is coupled to the apparatus:
wherein the different apparatus is a physical apparatus; and
wherein the physical apparatus generated the data from a phone call;
modifying a virtual environment using the call data; and
displaying, via a display system of the apparatus, the virtual environment to mirror the call data from the different apparatus to the virtual environment.

10. The method of claim 9, further comprising processing the call data to generate processed data.

11. The method of claim 10, wherein modifying the virtual environment further comprises modifying the virtual environment using the processed data.

12. The method of claim 10, wherein modifying the virtual environment further comprises modifying audio data of the virtual environment to include the processed data.

13. The method of claim 10, wherein modifying the virtual environment further comprises modifying image data of the virtual environment to include the processed data.

14. The method of claim 10, wherein modifying the virtual environment further comprises modifying haptic data of the virtual environment to include the processed data.

15. A non-transitory machine-readable medium having computer-readable instructions, which when executed by a computer, cause the computer to:
receive, at a processor of an apparatus, call data for display from a physical phone that is coupled to the physical apparatus;
modify image data for a virtual environment using the call data;
modify the image data to include a prompt for functions to be performed utilizing the call data;
display, via a display system of the apparatus, the modified image data in the virtual environment to mirror the call data from the different apparatus to the virtual environment; and
perform a function based on a user interaction with the prompt.

16. The machine-readable medium of claim 15, wherein the function is provided by a device other than the physical phone.

17. The machine-readable medium of claim 15, wherein the function filters the call data.

18. The machine-readable medium of claim 15, wherein the function modifies an avatar of the virtual environment to recite the call data.

19. The machine-readable medium of claim 15, wherein the function generates an avatar to recite the call data and wherein the avatar corresponds to a profile of a participant of a phone call implemented using the physical phone.

20. The machine-readable medium of claim 15, wherein the apparatus is further configured to provide response data to the physical phone responsive to receipt of a user interaction with the call data.
